(19) United States
(12) Patent Application Publication
(10) Pub. No.: US 2024/0410261 A1
(43) Pub. Date: Dec. 12, 2024

(54) Systems and Methods for Conducting Hydraulic Fracturing Operations

(71) Applicant: Halliburton Energy Services, Inc., Houston, TX (US)

(72) Inventors: Ronald Glen Dusterhoft, Houston, TX (US); Neil Alan Stegent, Houston, TX (US); Robert Barree, Lakewood, CO (US)

(21) Appl. No.: 18/207,315

(22) Filed: Jun. 8, 2023

(51) Int. Cl. E21B 43/26; E21B 49/00

(52) U.S. Cl. CPC E21B 43/26; E21B 49/00; E21B 43/30; E21B 2200/20; G01V 2210/663; G01V 2210/667

(57) ABSTRACT

A method of designing a multi-well fracturing operation comprising determining a probability of a large fracture stress extending from a treatment wellbore contacting an observation wellbore with a fracture model. The treating wellbore and the observation wellbore are arranged in a wellbore pattern within a subterranean formation. Determining with the fracture model a probability of a small fracture stress from a fracturing operation on the observation wellbore providing a threshold value of fracture conductivity to achieve a desired drainage radius for the observation wellbore. Outputting the treatment wellbore, the observation wellbore, the wellbore pattern, and the fracturing operation in response to the volume of fracturing fluid utilized in the observation wellbore being less than a threshold value.

### BACKGROUND

Hydrocarbons, such as oil and gas, are commonly obtained from subterranean formations that may be located onshore or offshore. The construction of a hydrocarbon producing well can comprise a number of different steps. Typically, the construction begins with drilling a wellbore at a desired wellsite, treating the wellbore to optimize production of hydrocarbons, and performing the necessary steps to produce and process the hydrocarbons from the subterranean formation. In the production of hydrocarbons from a subterranean formation, the subterranean formation should be sufficiently conductive to permit the flow of desirable fluids to a well bore penetrating the formation. One type of treatment used in the art to increase the conductivity of a subterranean formation is hydraulic fracturing. Hydraulic fracturing operations generally involve pumping a treatment fluid (e.g., a fracturing fluid or a “pad fluid”) into a wellbore that penetrates a subterranean formation at or above a sufficient hydraulic pressure to create or enhance one or more pathways, or “fractures,” in the subterranean formation. These fractures generally increase the permeability and/or conductivity of that portion of the formation. The fluid may comprise particulates, often referred to as “proppant,” that are deposited in the resultant fractures. Proppant may help prevent the fractures from fully closing upon the release of the hydraulic pressure, forming conductive channels through which fluids may flow to a well bore.

In certain instances, it may be desirable to construct multiple wells on or approximate the same wellsite to gather hydrocarbons from a subterranean formation. Each step of the construction of these multiple wells can be performed in succession and often with the same equipment. In some instances, it may be desirable to perform the hydraulic fracturing on these same multiple wellbores in a sequence or at the same time. Currently, the design of fracturing operations for these multiple wellbores can be designed individually or utilize the same treatment design for each wellbore. Often the fractures extending from or propagating from one wellbore may encounter or interfere with a fracture propagation from a prior wellbore. A method that accounts for fracture interference between wellbore fracture operations is desirable.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1A is a partial cross-sectional side view of a multi-well production system according to an embodiment of the disclosure.

FIG. 1B is a partial cross-sectional front view of a multi-well production system according to an embodiment of the disclosure.

FIG. 1C is a partial cross-sectional top view of a first fracturing operation on a multi-well production system according to an embodiment of the disclosure.

FIG. 1D is a partial cross-sectional top view of a multi-well production system at the completion of the fracturing operation according to an embodiment of the disclosure.

FIG. 2 is a logical block diagram of a method suitable for implementing one or more embodiments of the disclosure.

FIG. 3A is a partial cross-sectional front view of a multi-well production system according to another embodiment of the disclosure.

FIG. 3B is an illustration of a fracturing fleet coupled to a multi-well production system according to another embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Currently, companies providing wellbore services are being asked by regulators to reduce the wellbore operations emissions by lowering the allowable emission targets. Wellbore operations emissions include carbon dioxide as well as nitrogen oxides and Sulphur based compounds. Under current planning, the goal for the wellbore servicing industry is to continually reduce the total emissions year over year with a transition to electric wellbore services. A reduction in the wellbore servicing emissions while effectively providing the wellbore services at the wellsite is desirable.

Additionally, wellbore services providers are experiencing an increase in the cost of commodity materials from local economic drivers and supply constraints. The supply of commodity materials, for example, water, sand and chemicals, can increase the cost of providing services and create logistical bottle necks due to availability. A reduction in the commodity materials utilized in a wellbore servicing operation, for example, a fracturing operation, is desirable.

Certain embodiments according to the present disclosure may be directed to methods and systems for effectively stimulating each wellbore within a pad comprising multiple wells while also managing the total fluid injected, proppant placed into the formation, and chemicals utilized during a hydraulic fracturing operation. The design of the fracturing operation can identify and quantify the interactions of fractures from each wellbore of the multiple wells. The fracturing operation can effectively stimulate each wellbore of the multiple wells by identifying fracture interaction and in some cases fracture interference. As a result of designing the fracturing operation for multiple wells, the total quantity of materials utilized and the total energy consumed during hydraulic fracturing operations can be significantly reduced.

One solution to reduce the materials and total energy consumed can be a design process of proactive multi-well hydraulic fracture operation planning. In some embodiments, the design process can comprise the design of the pumping schedule, e.g., fracture stages, for each wellbore while managing the completion sequencing and altering the fracture treatment design and volumes based on when a given treatment in a given well is performed within the sequence of operations. In some embodiments, the design process can begin with, or specify treatment of, the outer most wellbores of the multi-well fracture operation. The outer wellbores can receive larger treatment fluid volumes within each stage to create long fractures and generate a large stimulation volume. For example, in a five well hydraulic fracture operation, the design process can specify well number one and five to receive a larger treatment per stage. Subsequently, the design process can specify the inner wellbores of the multi-well fracture operation receive smaller fluid volumes. For example, the design process can specify well number two and four to receive a smaller treatment than well one and five. The design process can design a wellbore treatment plan to connect the innermost wellbore fractures to the already created fracture systems of the previously outermost fractured wells. As a result, the total volume of fluid injected for the multi-well hydraulic fracture operation can be significantly reduced, while also significantly reducing the total energy requirement, and resulting emissions, in a multi-well completion operation.

Disclosed herein is a method of lowering the volume of materials utilized and the total energy required to fracture multiple wells penetrating the same reservoir. A design process to simulate the fracture propagation from each treatment stage and identify the location of the fracture stresses with the subterranean formation. The design process can determine a probability of fracture stress interference between fracture stages and/or between multiple wellbore treatments. The design process can predict the fracture stress level and fracture stress locations of the inner wellbores after the fracture operation of the outer wellbores. The design process can determine location of the wellheads at surface and the location of the wellbores within the formation. The fracture modeling can include well spacing, well completion sequencing, fracture stage spacing, fracture stage sequencing, and identification of fracture interference. The design of the fracturing operation can include a pumping schedule with wellbore treatment volumes. In some embodiments, wellbore monitoring techniques can be utilized to provide feedback to real time fracturing operations. The design process can reduce the volume of materials and energy utilized to fracture multiple wells while providing effective stimulation of each wellbore.

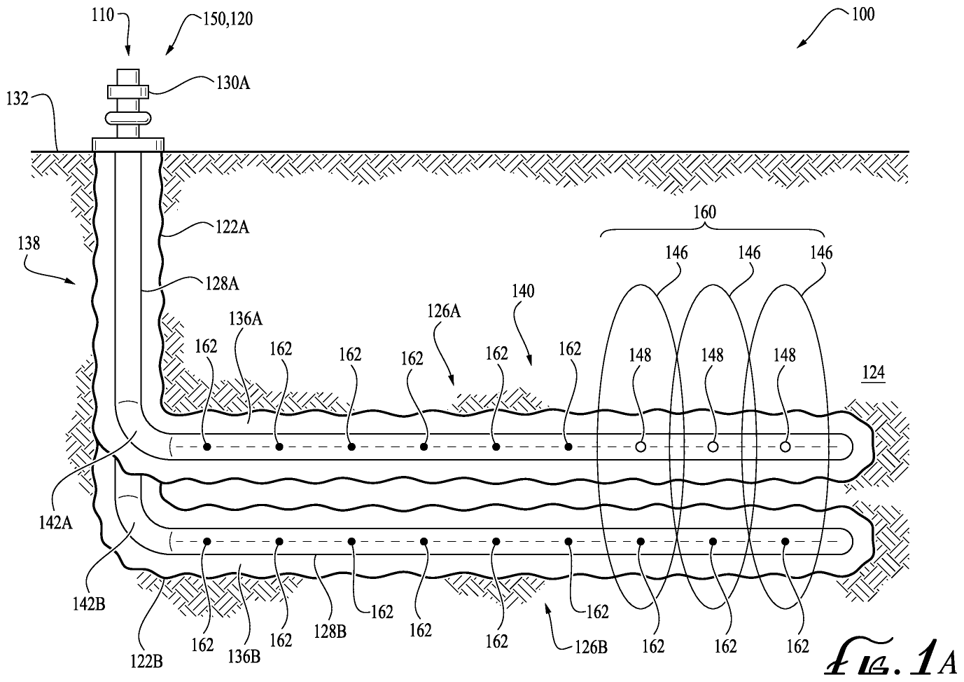

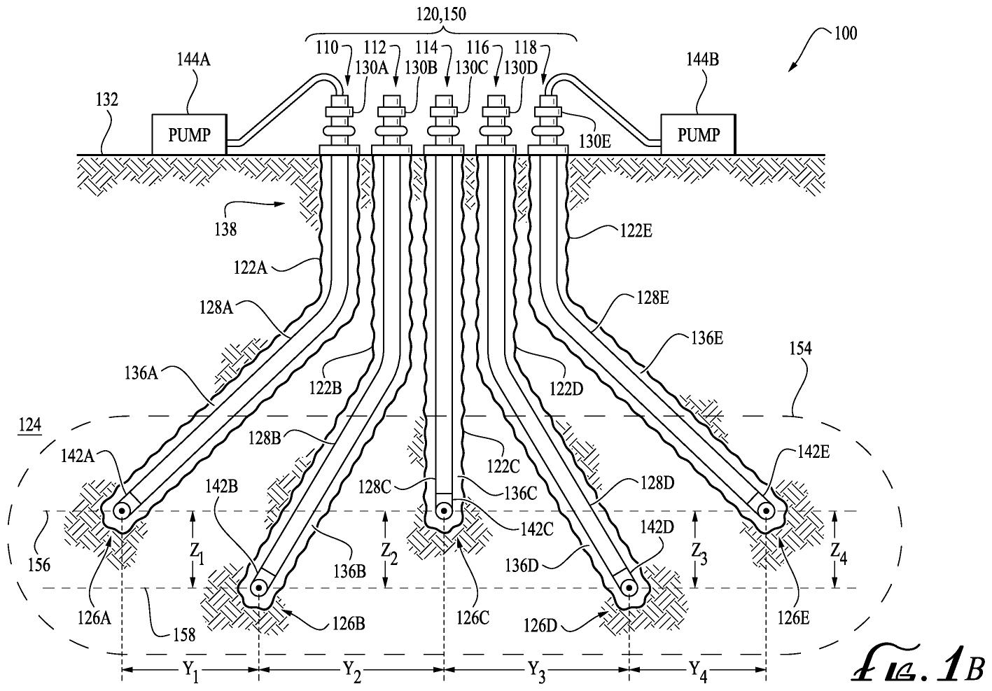

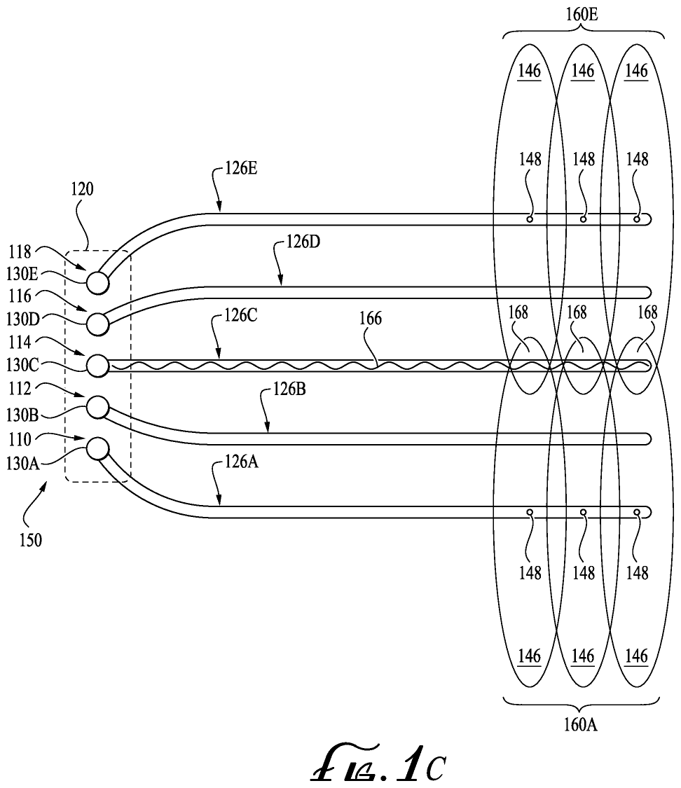

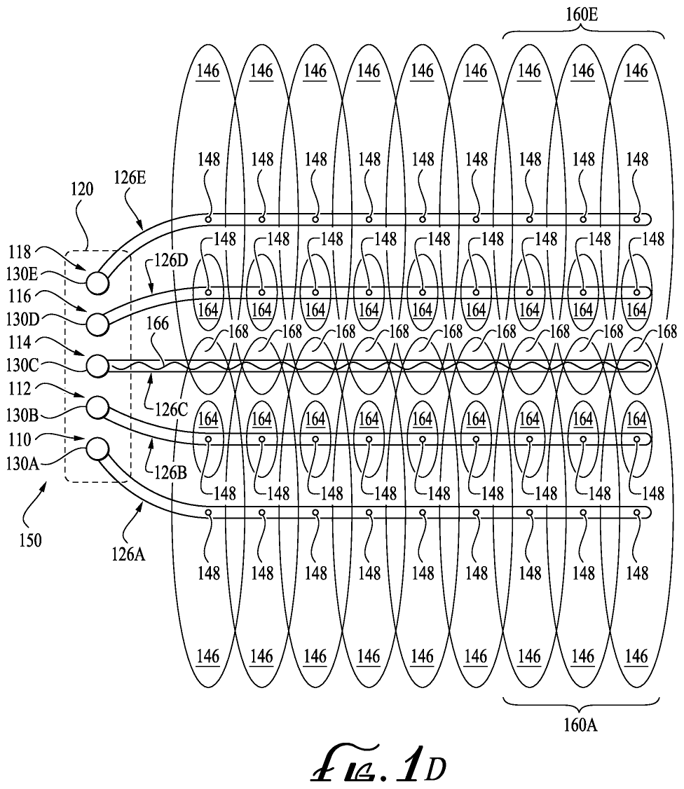

A multi-well hydraulic fracturing operation can be located on a well pad of a remote wellsite. The well pad can comprise a plurality of wellheads, for example, two or more wellheads within close proximity. The hydraulic fracturing operation can perform a pumping operation on one wellbore at a time or simultaneously on more than one wellbore during the operation. Turning now to FIGS. 1A and 1B, a partial cross-section side view and front view (respectively) of a fracturing operation environment 100 can be described. In some embodiments, the fracturing operation can comprise a plurality of production wells 150, e.g., production well 110, located on a well pad 120 at a remote wellsite. The production well 110 can comprise a wellbore 122A drilled with a generally horizontal path 126A into a subterranean formation 124. A casing string 128A can extend from a production wellhead 130A at surface 132 into the wellbore 122A. In some embodiments, the production well 110 comprises a vertical section 138, and a generally horizontal section 140 extending along a horizontal X-Y plane. The vertical section 138 can be coupled to the horizontal section 140 by a first transition section 142A. A cement sheath 136A can be placed between the wellbore 122A and the casing string 128A to anchor and isolate the casing string 128A from the wellbore fluids. In some embodiments, the casing string 128A and/or cement sheath 136A can extend to the distal end of the wellbore 122 or a portion of the length of the wellbore 122A from surface 132. For example, the casing string 128 can extend to the distal end of the wellbore 122A with cement sheath covering the vertical section 138 but not the horizontal section 140. In another scenario, the casing string 128 may extend through the vertical section 138 and a portion or percentage of the horizontal section 140, for example, 50 percent. In some embodiments, a completion string, e.g., liner with casing valves, can extend from the horizontal section 140 to the distal end of the wellbore 122A.

With reference to FIG. 1B, the well pad 120 can comprise a plurality of production wells 150, for example, production well 110, production well 112, production well 114, production well 116, and production well 118. The wellheads of the plurality of production wells 150 can be located proximate to each other. For example, wellhead 130 for the production well 110 can be located proximate or next to wellhead 130B. Wellhead 130B for the production well 112 can be located proximate or between wellhead 130A and wellhead 130C. Wellhead 130C for the production well 114 can be located proximate or between wellhead 130B and wellhead 130D. Wellhead 130D for the production well 116 can be located proximate or between wellhead 130C and wellhead 130E. Wellhead 130E for the production well 118 can be located distal to wellhead 130A or proximate wellhead 130D. Although the exemplary well pad 120 is illustrated with five production wells, e.g., the plurality of production wells 150, it is understood that the plurality of production wells 150 on the well pad 120 can comprise 2, 3, 4, 5, 6, 7, 8, 9, 10, 11, 12, 13, 14, 15, 16, 17, 18, 19, 20, or any number of production wells.

Each production well, e.g., production well 112, can comprise the same components as production well 110 but the location of the components, relative to production well 110, may vary. For example, production well 112 can comprise a wellhead 130B, wellbore 122B with a vertical section 138 and horizontal section 140, a casing string 128B, a cement sheath 136B, or combinations thereof. Production well 114 can comprise a wellhead 130C, wellbore 122C with a vertical section 138 and horizontal section 140, a casing string 128C, a cement sheath 136C, or combinations thereof. Production well 116 can comprise a wellhead 130D, wellbore 122D with a vertical section 138 and horizontal section 140, a casing string 128D, a cement sheath 136D, or combinations thereof. production well 118 can comprise a wellhead 130E, wellbore 122E with a vertical section 138 and horizontal section 140, a casing string 128E, a cement sheath 136E, or combinations thereof.

The horizontal path, e.g., horizontal path 126A, of each production well may be arranged in a wellbore pattern 154. For example, the horizontal path 126B of production well 112 may be located a distance Y1 along a horizontal plane and Z1 along a vertical plane from the horizontal path 126A of production well 110. The horizontal path 126C of production well 114 may be located a distance Y2 along a horizontal plane and Z2 along a vertical plane from the horizontal path 126B of production well 112. The horizontal path 126D of production well 116 may be located a distance Y3 along a horizontal plane and Z3 along a vertical plane from the horizontal path 126C of production well 114. The horizontal path 126E of production well 118 may be located a distance Y4 along a horizontal plane, e.g., xy-plane, and Z4 along a vertical plane from the horizontal path 126D of production well 116. In the exemplary wellbore pattern 154, the horizontal path 126A, 126C, 126E can be located at a measured depth 156 from surface 132 and the horizontal path 126B, 126D can be located at a measured depth 158 from surface 132. Although five production wells and the wellbore pattern 154 of the horizontal path of each production well is illustrated, it is understood that the number of production wells and the wellbore pattern 154 is exemplary for the description of the fracturing operation environment 100. The wellbore pattern 154 of the horizontal paths for each production well may be determined by a design process as will be described further herein.

With reference to FIG. 1B, at least one fracturing fleet 144A, e.g., a plurality of pumps, can be coupled to the wellhead 130A via a high pressure line to pump a fracturing fluid into the formation 124 according to a pumping schedule, e.g., a sequence of steps comprising fluid volumes and flowrates. The first fracturing operation, e.g., the plurality of pumps 144, can produce a facture plume 146 (as shown in FIG. 1A), also referred to as a fracture ellipse or a fracture stress, through each open initiation point 148 in the casing string 128. The stress level of each fracture stress created from each fracture plume 146 can be a function of the volume of proppant, e.g., sand, and fluid displaced into the formation 124. The illustration of the fracture plume 146 represents the fracture growth of the fracture fluid, e.g., proppant and water, cracking or splitting the formation 124 and propagating into a horizontal fracture plane, e.g., xy-plane. The horizontal fracture plane can be generally parallel to the horizontal portion 126 of the wellbore 122.

In some embodiments, the horizontal path, e.g., horizontal path 126A, can comprise a plurality of initiation points or locations along the casing string 128A that can be fluidically coupled to the formation 124. The casing string, e.g., casing string 128A, of each production well, e.g., production well 110, can comprise a plurality of closed initiation points 162, e.g., no fluid communication before the fracturing operation begins. In some embodiments, the fracturing operation can include a completion operation configured to open at least one closed initiation point 162. In some embodiments, the completion operation includes a perforating gun assembly that can be conveyed into the wellbore, e.g., wellbore 122A, to a target location to reconfigure at least one closed initiation point 162 to at least one open initiation point 148 by perforating the wellbore with a set of perforating guns. In some embodiments, the initiation points, e.g., closed initiation point 162, can be a casing valve and the completion operation can convey a shifting tool to reconfigure a closed casing valve, e.g., closed initiation point 162, to an open initiation point 148.

In some embodiments, the fracturing operation may be performed in stages or a sequence of pumping operations into a portion of the wellbore. For example, the first stage of a completion operation can reconfigure, e.g., open, at least one closed initiation point 162 to at least one open initiation points 148. The first stage 160 of the fracturing operation, e.g., pumping operation with the fracturing fleet 144A, can comprise pumping a fracturing fluid into a portion of the wellbore 122A open to the formation 124, e.g., open initiation points 148.

Turning now to FIG. 1C, at least one production well, e.g., production well 114, can include at least one sensor to measure one or more properties of the wellbore environment. In some embodiments, one or more wellbore sensors 166 can be fluidically connected to the wellhead, e.g., wellhead 130C. In some embodiments, one or more wellbore sensors 166 can be coupled to the casing string 128C. For example, one or more wellbore sensors 166 can be coupled to the outside of the casing string 128C and communicatively coupled to data monitoring device at surface 132. In another scenario, the wellbore sensor 166 can be coupled to an inner surface or conveyed inside of the casing string 128C. In some embodiments, one or more wellbore sensors 166 can be distributed optical sensors, for example, fiber optic cables. In some embodiments, the wellbore sensors 166 can be electronic sensors communicatively coupled to the data monitoring device by a cable. In some embodiments, the wellbore sensors 166 can be battery powered electronic sensors transmitting data to the surface via sonar, radio, or audio telemetry. In some embodiments, the wellbore sensors 166 can be a combination of sensor types. In some embodiments, i) all, ii) a portion, or iii) at least one of the plurality of production wells 150 include at least one wellbore sensor 166 and/or at least one sensor type.

The data gathered by the wellbore sensors 166 can include mechanical properties such as stress or strain data, flow rate data, pressure data, temperature data, acoustic data, compositional data, or combinations thereof. The wellbore sensors 166 can measure stress and strain from a strain-bridge mounted onto the outside surface or inside surface of the casing string. The wellbore sensors 166 can measure pressure and temperature at a discrete location within the cement sheath and/or along a portion of the casing string 128C. The wellbore sensors 166 can measure environmental properties of the formation 124, e.g., pressure and temperature. The wellbore sensors can measure environmental property data from the interior of the casing string 128C. The wellbore sensors 166 may be a fiber optical sensor that can measure a distributed temperature, acoustical data, stain data, stress data, pressure data or combinations thereof along the length of the fiber optic cable or at discrete locations along the length of the fiber optic cable. In some embodiments, the wellbore sensors 166 can measure stress and stain during the fracturing operation on at least one of the production wells, e.g., production well 110.

In some embodiments, a second fracturing fleet 144B, e.g., a plurality of pumps, can be fluidically coupled to the wellhead 130E via high pressure line to pump a fracturing fluid into the formation 124 simultaneously or concurrently with the first fracturing fleet 144A. For example, the second fracturing fleet 144B can perform a pumping operation on production well 118 while the first fracturing fleet 114A is performing a pumping operation on production well 110. In a first scenario, the first fracturing fleet 114A and second fracturing fleet 114B are pumping into i) the same stage or ii) different stages at the same time. In another scenario, the first fracturing fleet 114A and second fracturing fleet 114B are alternating pumping into i) the same stage or ii) different stages. For example, the second fracturing fleet 114B may delay pumping into a given stage, e.g., stage 160E, until the first fracturing fleet 114A completes the stage it is currently pumping, e.g., stage 160A.

A method of reducing the volume of materials utilized and the total energy required to fracture a reservoir at a multi-well pad can be described. As previously described, the outer wellbores, e.g., well 110 and well 118, can be fractured first before the inner wellbores. As shown in FIG. 1C, the fracture plumes 146, e.g., areas of fracture stress, can extend along a horizontal fracture plane to encounter and pass one or more inner wellbores, e.g., well path 126B-D. In some embodiments, the fracture plumes 146 from the outer wellbores, horizontal path 126A and horizontal path 126E, can combine in a zone of fracture interference. The fracture interference zone 168 can be a volume of formation rock with fracture stress provided by one or more plumes. In some embodiments, the fracture interference zone 168 can divert one of the fracture plumes 146 away from the fracture interference zone 168 and into a portion of the formation rock without fracture stress. Although FIG. 1C illustrates a first stage 160A, 160E of the fracture operation on production wells 110, 118, it is understood that the fracturing operation can continue with a second, third, fourth, fifth, sixth, seventh, or any number of stages until the horizontal path 126A, 126E have received the designed fracture treatment.

Turning now to FIG. 1D, the inner wellbores can receive a smaller treatment volume than the outer wellbores. In some embodiments, the inner wellbores, e.g., wellbore 122B-D, can be fractured to produce small fracture plumes 164 within the large fracture plumes 146 of the outer wellbores, e.g., 122A and 122B. These smaller fractures, e.g., small fracture plumes 164, are within the stimulated rock volume and can be designed to create local conductivity around the interior wellbores e.g., wellbore 122B-D, and connect to the preexisting fracture systems created while treating the outer wellbores, to enable oil to flow into them while connecting to the existing stimulated volume, e.g., large fracture plumes 146. In some embodiments, a fracture fluid comprising a higher strength gel systems and higher proppant concentrations can be utilized for the fracture operation of the interior wells, e.g., wellbores 122B-D. In some embodiments, the volume of fracture fluid utilized per stage on the inner wellbores may be reduced by as much as 80% compared to the volume of fluid utilized on the outer wellbores.

The fracture operation of the inner wells, e.g., well 112, 114, & 116, can comprise the same general steps or procedure as utilized on the outer wells but with a reduced volume of fracture fluid, proppant and chemical. For example, the fracture operation on well 112 and well 114 can be performed simultaneously or concurrently with the same fracture fleet previously described. The fracture operation can include a completion operation to reconfigure a plurality of closed initiation points 162 to open initiation points 148. As previously described, the completion operation can utilize a service string comprising a perforation gun assembly or a shifting tool to fluidically couple the casing string to the formation. In some embodiments, the fracture fleet can pump a reduced volume of fracturing fluid, proppant and chemical from the plurality of open initiation points 148 to generate small fracture plumes 164. The fracture operation can proceed in concurrent stages with a first stage producing small fracture plumes 164 from a first portion of the wellbore, e.g., wellbore 122B-D, followed by a second stage, a third stage, a fourth stage, and so on until the entire wellbore 122B-D has been completed.

In some embodiments, one or more wellbores may not be fractured. For example, the middle well 114 may not be fractured but the casing string 128C may be opened to the formation 124 as the region around this well has already been stimulated from jobs performed on adjacent wells. In some embodiments, a completion operation may fluidically couple the wellbore 122C, e.g., the casing string 128C, to the formation 124 with open initiation points 148. In some embodiments, the completion operation may install or provide a filter media, e.g., sand screen or sized slotted liner, within the wellbore 122C, the casing string 128, or both. In some embodiments, a filter media, e.g., gravel pack, can be installed within the casing string 128C.

Before the wellbores are drilled, the well pad 120, or pad site, can be designed with the plurality of wells 150 placed, or spaced out properly, so that the fracturing operation can be sequenced in a planned way to effectively utilize fracture stresses, e.g., large fracture plumes 146, generated during the early portion of the overall operation to effectively utilize small fracture plumes 164 during the later portions. In some embodiments, a design process can determine a location, e.g., the wellbore pattern 154, for the plurality of horizontal sections, e.g., path 126A-E, within the formation 124. The wellbore pattern 154 and a fracture operation for each of the plurality of wellbores, e.g., wellbore 122A, can be inputted into a fracture model. The fracture modeling process can be utilized to fully optimize the size and design of individual treatments to ensure optimum well placement, e.g., wellbore pattern 154, and treatment design for each individual stage in each well, e.g., production well 110. The fracture modeling process can be used to determine the most appropriate sequencing for the fracture plumes, e.g., fracture plumes 146, and treatment designs for the plurality of wellbores, e.g., wellbore 122A, within the wellbore pattern 154. In some embodiments, the total volume of fracturing fluid can be determined in barrels or gallons per acre of drainage volume, e.g., volume of large fracture plume 146 and/or small fracture plume 164. The total volume of fracturing fluids can provide a threshold value to benchmark the effectiveness of the design process in relation to reducing fluids, proppants, chemicals, total energy consumed and emissions generated.

In some embodiments, the design process can determine a wellbore pattern 154 for a plurality of production wells 150. For example, the design process can utilize a fracturing model to locate the horizontal path 126A of the wellbore 122A relative to the other wellbores 122B-E for a plurality of production wells 150. The design process can utilize a fracturing model to determine a first fracturing operation for at least one wellbore 122 comprising large fracturing plumes 146. In some embodiments, the first fracturing operation can comprise two, three, four, five, six, seven, eight, or more wellbores 122. In some embodiments, the design process can optimize the placement of the wellbores, e.g., the wellbore pattern 154, and the first fracturing operation based on a predicted wellbore stress level proximate to or located on at least one untreated wellbore within the wellbore pattern 154. For example, the design process can optimize the wellbore pattern 154 and the first fracturing operation to achieve a desired stress level threshold at an untreated wellbore, e.g., wellbore 122C, distal from a treated wellbore, e.g., wellbore 122A. In some embodiments, the design process can utilize the fracturing model to determine a second fracturing operation for at least one wellbore within the large fracturing plume 146 of the first fracturing operation, e.g., wellbore 122B. The second fracturing operation can utilize small fracturing plumes 164 to provide fracture conductivity to the at least one wellbore within the large fracturing plume 146.

The design process can be active during a fracturing operation. For example, the design process can modify a fracturing operation based on datasets from wellbore sensors. In some embodiments, the fracture model can compare one or more periodic datasets from wellbore sensors, e.g., wellbore sensor 166, to a modeled fracture design. The fracture model can compare real-time datasets to the fracture model during the pumping operation. The wellbore sensors 166 can be located within the wellbore being treated, for example, wellbore 122A or in a distal wellbore, for example, wellbore 122C. The distal wellbore, also referred to as an observation wellbore, can provide periodic datasets or real-time datasets of the wellbore environment, e.g., pressure, and strain measurements indicative of the fracturing operation being performed in the treating wellbore, e.g., wellbore 122A. For example, pressure sensors and fiber optic sensors can provide detailed information regarding the time when the fractures, e.g., large fracture plumes 146, hit the offset well. In the case of fiber optic sensors, the contact of the large fracture plumes 146 to the offset well, e.g., wellbore 122C, can be determined by the strain changes along the entire well, e.g., casing string 128C.

In some embodiments, real-time dataset from wellbore sensors 166, e.g., fiber optic sensors, within the treatment wellbore, e.g., wellbore 122A, can determine the perforation cluster, e.g., open initiation point 148, efficiency and the efficacy of the large fracture plumes 146 along the length of the fracture stage, e.g., stage 160A. In a scenario, one or two clusters, e.g., open initiation points 148, can take a disproportionate amount of fracturing fluid resulting in run-away fracture plumes. The design process can determine or identify a run-away fracture plume by comparing the real-time datasets to the fracture model. The design process can alert the fracture operation of the run-away fracture plume and modify the design of one or more stages of the fracturing operation based on the existence of the run-away fracture plume. The design process can optimize the number of clusters, the number of perforations per cluster, the diameter of the created perforations and the overall flow rate to optimize or form more uniform fractures by creating back pressure in the wellbore and helping to achieve a more uniform discharge rate per perforation over the entire interval.

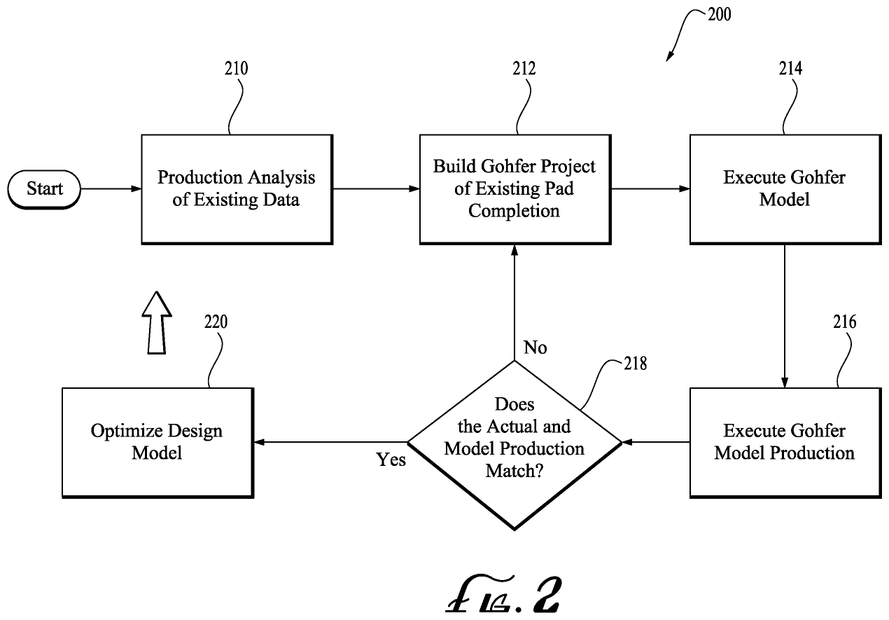

The design process can calibrate the fracture model with production data from at least one production well. Turning now to FIG. 2, a logical block diagram of a model calibration process 200 can be described. In some embodiments, production data from at least one production well, e.g., production well 114, can be utilized to calibrate the fracture model. In block 210, a periodic dataset indicative of fluid production from at least one production well 114 can be retrieved from a wellbore sensor coupled to the wellhead 130. In block 212, the modeled fracture design outputted from the design process can be inputted into the fracture design model. In block 214, the fracture model can retrieve the predicted fracture lengths from the modeled fracture design. In block 216, the fracture model can compare the production data to the predicted values. For example, Rate Transient Analysis (RTA) can be used to calculate an effective drainage radius round each of the wellbores, e.g., wellbore 122A-E. In block 218, the fracture model can determine an error value for a predicted fracture length and/or predicted effective fracture length by comparing production data and effective drainage radius information to the modeled fracture design. The error value can be determined by matching each of the predicted fracture effective fracture lengths to the observed effective drainage radius. In block 220, the fracture model can be modified to reduce the error value.

In some embodiments, re-fracturing can be incorporated later in the life of the reservoirs, or additional infill wells can be planned to reach regions that may not have been effectively drained with the initial completions.

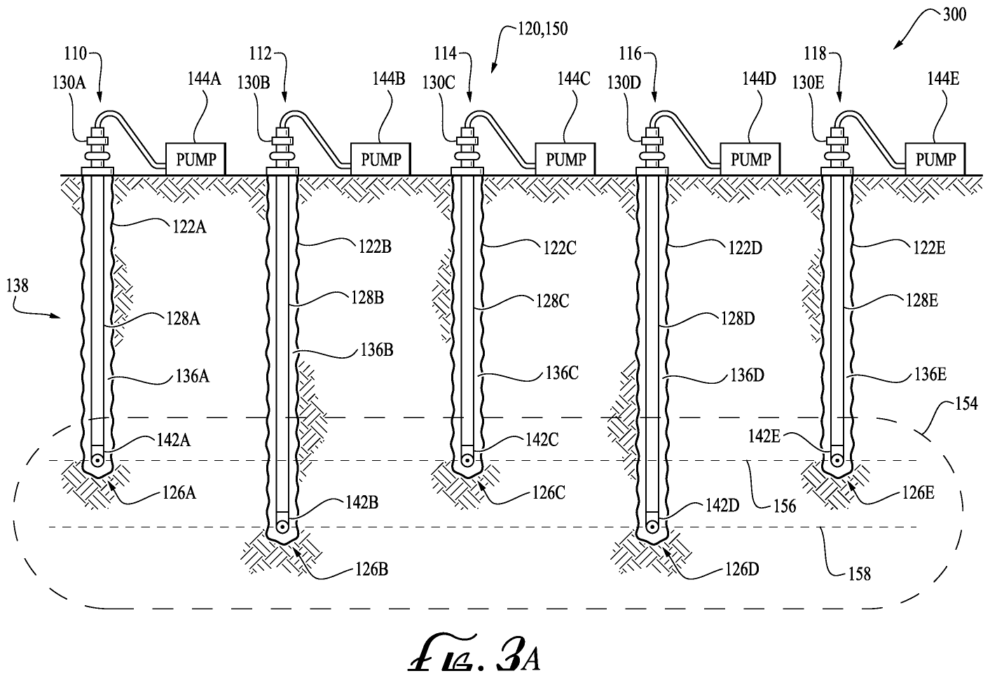

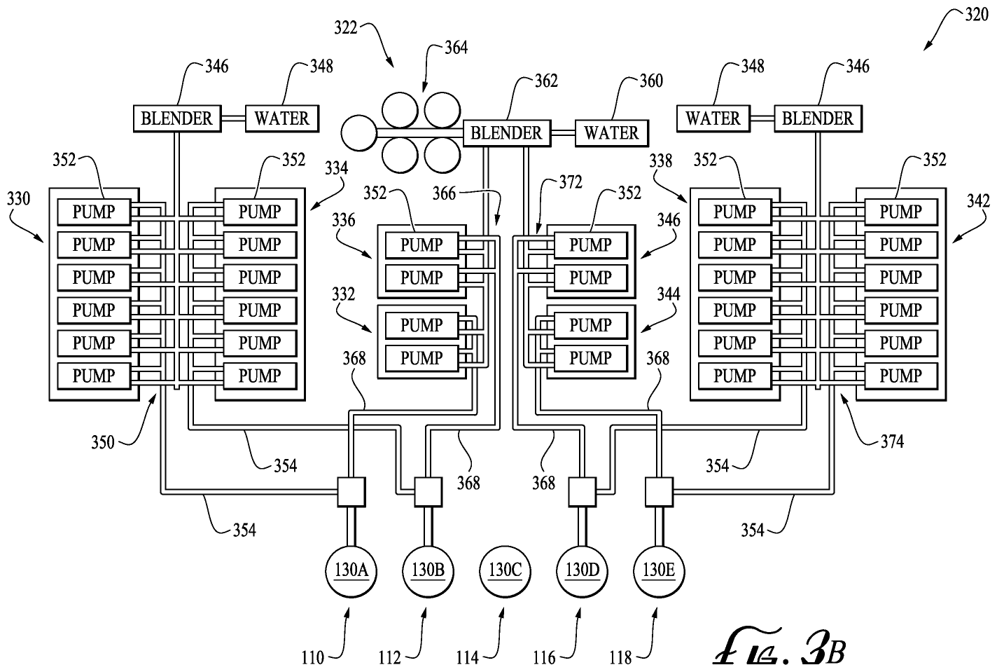

The fracture operation can be performed on multiple wellbores simultaneously or concurrently. Turning now to FIG. 3A, a partial cross-sectional drawing of a multi-well fracturing operation 300 can be described. In some embodiments, a fracturing fleet 144A-E can be fluidically coupled with each wellhead 130A-E of the plurality of wells 150 at the well pad 120. For example, a fracturing fleet 144A can be fluidically coupled to wellhead 130A of production well 110. A fracturing fleet 144B can be fluidically coupled to wellhead 130B of production well 112. A fracturing fleet 144C can be fluidically coupled to wellhead 130C of production well 114. A fracturing fleet 144D can be fluidically coupled to wellhead 130D of production well 116. A fracturing fleet 144E can be fluidically coupled to wellhead 130E of production well 118. In some embodiments, each of the fracturing fleets 114A-E can comprise a control unit to direct the pumping operation of that fracturing fleet. In some embodiments, a single control unit can be communicatively coupled to each of the fracturing fleets 114A-E.

Turning now to FIG. 3B, a block diagram of a multi-well fracturing operation 320 can be described. In some embodiments, a fracturing fleet can be divided into a plurality of clean pumping groups and a plurality of dirty pumping groups fluidically coupled to a plurality of wellbores. In the exemplary fracturing fleet 322 illustrated, a clean pump group 330 and a dirty pump group 332 can be fluidically coupled to the wellhead 130A of the production well 110. A clean pump group 334 and a dirty pump group 336 can be fluidically coupled to the wellhead 130B of the production well 112. A clean pump group 338 and a dirty pump group 340 can be fluidically coupled to the wellhead 130D of the production well 116. A clean pump group 342 and a dirty pumping group 344 can be fluidically coupled to the wellhead 130E of the production well 118. A system controller can be communicatively coupled to the plurality of clean pumping groups and the plurality of dirty pumping groups to direct the pumping operation. For example, the system controller can direct the clean pump group 334 and the dirty pump group 336 to deliver a fracturing fluid to the wellhead 130A per the pumping schedule.

The clean pump groups 330, 334 can be fluidically coupled to a clean blender 346 and/or a water supply 348 by a fluid network 350. The clean blender 346 can supply clean fluid, e.g., water, to the fluid network 350. The fluid network 350, also referred to as a manifold or missile, comprises a low pressure side to supply water to a plurality of clean pumps 352 and a high pressure side that delivers high pressure fluid from the plurality of clean pumps 352 to a high pressure supply line 354.

The dirty pump groups 336, 332 can be fluidically coupled to a dirty blender 362 by a fluid network 366. The dirty blender 362 can blend a fracturing fluid, also referred to as a dirty fluid, comprising water, some chemical additives, and proppant. The water can be delivered from a water supply 360. The proppant can be delivered from a proppant supply 364. The low pressure side of the fluid network 366 can supply dirty fluid to a plurality of dirty pumps in the dirty pump groups 336, 332 and a high pressure side of the fluid network 366 can deliver high pressure dirty fluid from the plurality of dirty pump group 336, 332 to a high pressure supply line 368.

The wellhead 130A of the production well 110 can receive a blended fracturing fluid from the clean pump group 330 and the dirty pump group 332. The clean pump group 330 can deliver clean fluid that is blended with dirty fluid from the dirty pump group 332 at the wellhead 130A or at a wye block proximate to the wellhead 130A. A wellbore sensor coupled to the wellhead 130A can provide feedback of the composition of the blended fracturing fluid, e.g., the density, pressure, and flowrate.

The wellhead 130B of the production well 112 can receive a blended fracturing fluid from the clean pump group 334 and the dirty pump group 336. The clean pump group 334 can deliver clean fluid that is blended with dirty fluid from the dirty pump group 336 at the wellhead 130B or at a wye block proximate to the wellhead 130B. A wellbore sensor coupled to the wellhead 130B can provide feedback of the composition of the blended fracturing fluid, e.g., the density, pressure, and flowrate.

The dirty pump groups 340, 344 can be fluidically coupled to the dirty blender 362 by a fluid network 372. The dirty blender 362 can deliver the dirty fluid to the fluid network 372. The low pressure side of the fluid network 372 can supply dirty fluid to a plurality of dirty pumps in the dirty pump groups 340, 344 and a high pressure side of the fluid network 372 can deliver high pressure dirty fluid from the plurality of dirty pumps in the dirty pump groups 340, 344 to a high pressure supply line 368.

The clean pumping groups 338, 342 can be fluidically coupled to a clean blender 346 and/or a water supply 348 by a fluid network 374. The clean blender 346 can supply clean fluid, e.g., water, to the fluid network 374. The fluid network 374 can deliver clean fluid to a plurality of clean pumps 352 and the high pressure side can deliver high pressure fluid from the plurality of clean pumps 352 to a high pressure supply line 354.

The wellhead 130D of the production well 116 can receive a blended fracturing fluid from the clean pump group 338 and the dirty pump group 340. The clean pump group 338 can deliver clean fluid that is blended with dirty fluid from the dirty pump group 340 at the wellhead 130D or at a wye block proximate to the wellhead 130D. A wellbore sensor coupled to the wellhead 130D can provide feedback of the composition of the blended fracturing fluid, e.g., the density, pressure, and flowrate.

The wellhead 130E of the production well 118 can receive a blended fracturing fluid from the clean pump group 342 and the dirty pumping group 344. The clean pump group 342 can deliver clean fluid that is blended with dirty fluid from the dirty pumping group 344 at the wellhead 130E or at a wye block proximate to the wellhead 130E. A wellbore sensor coupled to the wellhead 130E can provide feedback of the composition of the blended fracturing fluid, e.g., the density, pressure, and flowrate.

In some embodiments, the fracturing operation can follow the same fracturing sequence previously described. For example, the fracturing fleet 322 can begin fracturing operation on the outer production wells, e.g., production well 110 and production well 118. The fracturing operation can open a first stage of fracture initiation points 148 and produce a large fracture plume 146 by pumping fracturing fluid into formation. The fracturing operation can form the fracture plumes 146 within both production wells simultaneously, near simultaneously, or in a predetermined sequence.

In some embodiments, the fracturing operation can begin fracturing operation on the inner production wells, e.g., production well 112 and production well 116. The fracturing operation on the inner production wells can begin after the first stages of the outer production wells are completed. For example, the fracturing operation can begin the first stage on the inner wells after the outer wells compete the first stage pumping operation. In some embodiments, the fracturing operation on the inner production wells produce small fracture plumes 164 with the large fracture plumes of the outer production wells.

Although the exemplary fracturing fleet 322 is described as treating four wells, e.g., production well 110, 112, 116, 118, it is understood that the exemplary fracturing fleet 322 can treat any number of wells, for example, 2, 3, 4, 5, 6, 7, 8, or any number of production wells by adding or subtracting clean pumping groups and dirty pumping groups.

The exemplary fracturing fleet 322 is described as not treating production well 114. In some embodiments, at least one production well, e.g., production well 114, can be utilized as a monitoring well with at least one wellbore sensor providing real-time datasets to the control system. Although one production well is described as a monitoring well, it is understood that more than one production well may be utilized as a monitoring well.

### Additional Disclosure

The following are non-limiting, specific embodiments in accordance with the present disclosure:

A first embodiment, which is a system for producing hydrocarbons from a subterranean formation, comprising a first treatment wellbore extending from a surface well-pad into the subterranean formation; an observation wellbore extending from the surface well-pad into the subterranean formation; a second treatment wellbore extending from a surface well-pad into the subterranean formation, wherein the second treatment wellbore located between the first treatment wellbore and the observation wellbore; at least one wellbore sensor located within the observation wellbore; a fracturing fleet fluidically coupled to the first treatment wellbore comprising a plurality of pumping equipment and a system controller; a design process, executing on the system controller, controlling a pumping operation of the fracturing fleet to pump a fracturing fluid into the subterranean formation per a pumping schedule, wherein the design process is configured to perform the following: receive a real-time dataset from the at least one wellbore sensor; compare the real-time dataset to a modeled fracture design; determine a stress level of a plurality of large fracture stresses from the first treatment wellbore; determine a second fracture design for the second treatment wellbore in response to the stress level of the plurality of large fracture stresses, wherein the second fracture design comprises a second volume of treatment fluid and a second pumping schedule; and modify the pumping schedule for the first treatment wellbore in response to the second volume of fracturing fluid of the second fracture design exceeding a threshold value.

A second embodiment, which is the system of the first embodiment, further comprising determine i) an open initiation point, ii) a number of perforations per perforation cluster, iii) an efficiency of a plurality of perforations, iv) an efficacy of the perforation, or v) combinations thereof in response to the stress level of a plurality of large fracture stresses.

A third embodiment, which is the system of the first or second embodiment, wherein the at least one wellbore sensor is a fiber optic sensor installed inside a casing string of the observation wellbore.

A fourth embodiment, which is a method of designing a multi-well fracturing operation, comprising determining a probability of a large fracture stress from a first treating wellbore contacting at least one untreated wellbore by inputting a design wellbore pattern, a design first treating wellbore geometry, a design first fracturing operation, a set of geomechanical data for a subterranean formation, or combinations thereof into a fracture model; determining a probability of a small fracture stress from a design second fracture operation on a second treating wellbore providing a fracture conductivity to achieve a second predicted drainage radius of the second treating wellbore by inputting a design second treating wellbore geometry, a design second fracturing operation, a set of geomechanical data for a subterranean formation, or combinations thereof into a fracture model, and wherein the design second fracturing operation transforms the at least one untreated wellbore to the second treating wellbore; wherein the design second fracture operation comprises a smaller volume of fracturing fluid than the design first fracturing operation; modifying the design wellbore pattern, the design first fracturing operation, the design second fracturing operation, or combinations thereof in response to a volume of fracturing fluid utilized in the design second fracturing operation being greater than a threshold value; and outputting a working wellbore pattern, a first wellbore geometry, a second wellbore geometry, a first fracturing operation, a second fracturing operation, or combinations thereof, in response to the volume of fracturing fluid utilized in the second fracturing operation being less than a threshold value.

A fifth embodiment, which is the method of the fourth embodiments, wherein the set of geomechanical data comprises formation composition, porosity, depth, temperature, fracture plane orientation, or combinations thereof.

A sixth embodiment, which is the system of the fourth and the fifth embodiments, wherein the subterranean formation is a hydrocarbon bearing formation.

A seventh embodiment, which is the method of any of the fourth through the sixth embodiments, wherein the design first treating wellbore geometry further comprises a borehole, a casing string, a cement sheath, or combinations thereof.

An eighth embodiment, which is the method of any of the fourth through the seventh embodiments, wherein the design first fracturing operation comprises a completion operation configured to open a plurality of initiation points in the design first treating wellbore geometry.

A ninth embodiment, which is the method of any of the fourth through the eighth embodiments, wherein the design wellbore pattern comprises the first treating wellbore and the at least one untreated wellbore, wherein the at least one untreated wellbore is located along a fracture plane and proximate to the first treating wellbore.

A tenth embodiment, which is the method of any of the fourth through the ninth embodiments, wherein the design first fracturing operation comprises pumping a fracturing fluid according to a pumping schedule into the design first treating wellbore geometry.

An eleventh embodiment, which is the method of any of the fourth through the tenth embodiments, wherein the design wellbore pattern locates a second predicted drainage radius of the at least one untreated wellbore outside of a first predicted drainage radius of the first treating wellbore.

An twelfth embodiment, which is the method of any of the fourth through the eleventh embodiments, wherein the first predicted drainage radius and second predicted drainage radius are determined by a production model.

A thirteenth embodiment, which is the method of any of the fourth through the twelfth embodiments, wherein the design second fracturing operation comprises a second completion operation configured to open a plurality of initiation points in the design second treating wellbore geometry.

A fourteenth embodiment, which is the method any of the fourth through the thirteenth embodiments, wherein the first wellbore geometry comprises a generally horizontal path, and wherein the second wellbore geometry comprises a generally horizontal path.

A fifteenth embodiment, which is the method of any of the fourth through the fourteenth embodiments, wherein the design first fracturing operation comprises a plurality of fracturing stages; wherein the plurality of fracturing stages are completed sequentially; and wherein at least one large fracture stress from each of the plurality of fracturing stages contacts the at least one untreated wellbore.

A sixteenth embodiment, which is method of designing a fracturing operation at a wellsite, comprising retrieving, by a design process executing on a system controller, a revision one optimized fracturing design for a first fracturing operation from a database, and wherein the revision one optimized fracturing design comprises a fracturing fluid and pumping schedule for a treatment wellbore; receiving, by the design process, a real-time dataset indicative of a fracturing operation from an observation wellbore; updating, by the design process, the revision one optimized fracturing design to a revision two optimized fracturing design; and communicating the revision two optimized fracturing design to a fracturing fleet.

A seventeenth embodiment, which is the method of the sixteenth embodiments, wherein the system controller is communicatively coupled to the fracturing fleet.

A eighteenth embodiment, which is method of any of the sixteenth and the seventeenth embodiments, further comprises pumping a fracturing treatment, by the fracturing fleet, into the treatment wellbore; and determining an error value, by the design process, by comparing the real-time dataset to the revision one optimized fracturing design.

A nineteenth embodiment, which is the system of any of the sixteenth through the eighteenth embodiment, further comprises generating, by the design process, a revision two optimized fracturing design by inputting a wellbore pattern, a treating wellbore geometry, a set of geomechanical data, the revision one optimized fracturing design, the real-time datasets, or combinations thereof, into a fracture model.

A twentieth embodiment, which is the system of any of the sixteenth through the nineteenth embodiments, further comprises outputting the revision two optimized fracturing design in response to a probability of a large fracture stress from the treatment wellbore contacting the observation wellbore.

While embodiments have been shown and described, modifications thereof can be made by one skilled in the art without departing from the spirit and teachings of this disclosure. The embodiments described herein are exemplary only, and are not intended to be limiting. Many variations and modifications of the embodiments disclosed herein are possible and are within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the embodiments of the present disclosure. The discussion of a reference herein is not an admission that it is prior art, especially any reference that may have a publication date after the priority date of this application. The disclosures of all patents, patent applications, and publications cited herein are hereby incorporated by reference, to the extent that they provide exemplary, procedural, or other details supplementary to those set forth herein.

1. A system for producing hydrocarbons from a subterranean formation, comprising:
a first treatment wellbore extending from a surface into the subterranean formation;
an observation wellbore extending from the surface into the subterranean formation;
a second treatment wellbore extending from the surface into the subterranean formation,
wherein the second treatment wellbore is located between the first treatment wellbore and the observation wellbore;
at least one wellbore sensor located within the observation wellbore;
a fracturing fleet fluidically coupled to the first treatment wellbore comprising a plurality of pumping equipment and a system controller;
a design process, executing on the system controller, controlling a pumping operation of the fracturing fleet to pump a fracturing fluid into the subterranean formation per a pumping schedule, wherein the design process is configured to:
receive a real-time dataset from the at least one wellbore sensor;
compare the real-time dataset to a modeled fracture design;
determine a stress level of a plurality of large fracture stresses from the first treatment wellbore;
determine a second fracture design for the second treatment wellbore in response to the stress level of the plurality of large fracture stresses, wherein the second fracture design comprises a second volume of treatment fluid and a second pumping schedule; and
modify the pumping schedule for the first treatment wellbore in response to the second volume of fracturing fluid of the second fracture design exceeding a threshold value.

2. The system of claim 1, wherein the design process is further configured to:
determine i) an efficiency value of an open initiation point, ii) an efficacy value of the open initiation point, or iii) both, by comparing the real-time dataset to a modeled fracture design; and
modify the pumping schedule for the first treatment wellbore in response to the efficiency value or efficacy value of the open initiation point exceeding a threshold value.

3. The system of claim 1, wherein the at least one wellbore sensor is a fiber optic sensor installed inside a casing string of the observation wellbore.

4. A method of hydraulic fracturing, comprising:
inputting design parameters into a model, wherein the design parameters are of a first wellbore, a second wellbore, a first fracturing operation, and a second fracturing operation;
determining, using the model in which the design parameters are input, a first fracture stress and a first volume of injected fracturing fluid resulting from treating the first wellbore according to the first fracturing operation to achieve a first drainage radius of the first wellbore;
determining, using the model in which the design parameters are input, a second fracture stress and a second volume of injected fracturing fluid resulting from treating the second wellbore according to the second fracturing operation to achieve a second drainage radius of the second wellbore, wherein the second fracture stress is less than the first fracture stress, and wherein the second volume of fracturing fluid is less than the first volume of fracturing fluid;
revising the design parameters, in response to the determined second volume of fracturing fluid being greater than a threshold value;
inputting the revised design parameters into the model;
redetermining, using the model in which the revised design parameters are input, the first fracture stress and the first volume of injected fracturing fluid resulting from treating the first wellbore according to the first fracturing operation to achieve the first drainage radius;
redetermining, using the model in which the revised design parameters are input, the second fracture stress and the second volume of injected fracturing fluid resulting from treating the second wellbore according to the second fracturing operation to achieve the second drainage radius;
outputting the revised design parameters, in response to the redetermined second volume of fracturing fluid being less than the threshold value; and
executing a physical fracturing operation of two wellbores to cause connection of fractures of the two wellbores, according to the output revised design parameters.

5. The method of claim 4, wherein the model is based on a set of geomechanical data comprising formation composition, porosity, depth, temperature, fracture plane orientation, or combinations thereof.

6. The method of claim 5, wherein the set of geomechanical data is of a hydrocarbon bearing formation.

7. The method of claim 4, wherein the first wellbore comprises a borehole, a casing string, a cement sheath, or combinations thereof.

8. The method of claim 4, wherein the first fracturing operation comprises a completion operation configured to open a plurality of initiation points in the first wellbore.

9. The method of claim 4, wherein one of the two wellbores is located along a fracture plane and proximate to another of the two wellbores.

10. The method of claim 4, wherein the first fracturing operation comprises pumping the first volume of fracturing fluid according to the design parameters, which include a pumping schedule of the first wellbore.

11. The method of claim 4, wherein the design parameters comprise a wellbore pattern.

12. The method of claim 11, wherein the first drainage radius and the second drainage radius are determined by the model.

13. The method of claim 4, wherein the second fracturing operation comprises a completion operation configured to open a plurality of initiation points in the second wellbore.

14. The method of claim 4, wherein the first wellbore comprises a first horizontal path, and wherein the second wellbore comprises a second horizontal path.

15. The method of claim 4, wherein the first fracturing operation comprises a plurality of fracturing stages, and wherein the plurality of fracturing stages are completed sequentially.

16. A method of designing a fracturing operation at a wellsite, comprising:
retrieving, by a design process executing on a system controller, a revision one optimized fracturing design for a first fracturing operation from a database, and wherein the revision one optimized fracturing design comprises a fracturing fluid and pumping schedule for a treatment wellbore;
receiving, by the design process, at least one real-time dataset indicative of a fracturing operation from an observation wellbore;
updating, by the design process, the revision one optimized fracturing design to a revision two optimized fracturing design; and
communicating the revision two optimized fracturing design to a fracturing fleet.

17. The method of claim 16, wherein the system controller is communicatively coupled to the fracturing fleet.

18. The method of claim 16, further comprises:
pumping a fracturing treatment, by the fracturing fleet, into the treatment wellbore; and
determining an error value, by the design process, by comparing the at least one real-time dataset to the revision one optimized fracturing design.

19. The method of claim 16, further comprises:
generating, by the design process, a revision two optimized fracturing design by inputting a wellbore pattern, a treating wellbore geometry, a set of geomechanical data, the revision one optimized fracturing design, the at least one real-time dataset, or combinations thereof, into a fracture model.

20. The method of claim 19, further comprising:
outputting the revision two optimized fracturing design in response to a probability of a large fracture stress from the treatment wellbore contacting the observation wellbore.
